(19) United States
(12) Patent Application Publication
(10) Pub. No.: US 2015/0073584 A1
(43) Pub. Date: Mar. 12, 2015

(54) WIRELESS VISION SYSTEMS AND METHODS FOR USE IN HARSH ENVIRONMENTS

(71) Applicants: Andrew Goodale, Maynard, MA (US); Schilling Schilling, Brookline, MA (US); David R King, Hudson, MA (US); George Costigan, Westford, MA (US); Lei Wang, Wayland, MA (US)

(72) Inventors: Andrew Goodale, Maynard, MA (US); Schilling Schilling, Brookline, MA (US); David R King, Hudson, MA (US); George Costigan, Westford, MA (US); Lei Wang, Wayland, MA (US)

(21) Appl. No.: 14/482,518

(22) Filed: Sep. 10, 2014

Related U.S. Application Data
(60) Provisional application No. 61/875,774, filed on Sep. 10, 2013.
(60) Provisional application No. 61/899,684, filed on Nov. 4, 2013.

(51) Int. Cl. G05B 19/4097

(52) U.S. Cl. CPC G05B 19/4097; G05B 2219/45145
USPC 700/186; 700/159

(57) ABSTRACT

A chuck or spindle mountable wireless vision system and method for use in harsh environments. The vision system includes a sealed housing. The sealed housing includes a tool holder interface to couple to the chuck or spindle of a machine. An optical system to acquire an image is positioned within the sealed housing, the optical system including a processor, memory, and machine vision software to perform at least a portion of image processing. A wireless communication module is operatively coupled to the optical system to wirelessly communicate image data. And, a power source, the power source operatively coupled to the optical system and the wireless communication module.

### CROSS-REFERENCE TO RELATED APPLICATIONS

This application claims the benefit of U.S. Provisional Patent Application Ser. No. 61/875,774, filed Sep. 10, 2013, and entitled “Wireless Vision System For Use By CNC Machines.” This application also claims the benefit of U.S. Provisional Patent Application Ser. No. 61/899,684, filed Nov. 4, 2013, and entitled “Wireless Vision System For Use By CNC Machines,” both of which are hereby incorporated by reference.

### STATEMENT REGARDING FEDERALLY SPONSORED RESEARCH OR DEVELOPMENT

Not applicable.

### BACKGROUND OF THE TECHNOLOGY

The present technology relates to wireless vision systems, and more specifically, to a wireless vision system for use in harsh environments.

Computer Numerical Control (CNC) machines are well known and are used to substantially automate the production of a component or part. The part design can be developed using computer-aided design (CAD) and computer-aided manufacturing (CAM) programs, and then a part file can be transferred to the CNC machine to produce the part. Many CNC machines use a variety of interchangeable tools to produce the part, such as lasers, welders, drills, saws, and an assortment of other tools.

It can be helpful to determine precise positioning of a part, or features on the part, during the production process. CNC machines often use touch probes to mechanically locate parts on the CNC work surfaces before or after an operation. Touch probes operate by physically touching parts at multiple locations to obtain accurate dimensions of the part itself. CNC touch probes can be battery operated, have wireless communication, and can be used for measuring and fixturing parts. Examples are touch probes from Renishaw Inc. of Hoffman Estates, Ill. Some touch probes can be retrofitted to work with CNC machines with measuring capabilities.

Vision systems have also been modified to work in a CNC environment. For example, cameras have been fixed mounted to the side of a CNC spindle. These side-mounted cameras then use machine vision algorithms for fixturing and inspecting parts being worked on by the CNC machine. These side-mounted camera systems require extensive modification or a CNC machine purpose-built with such a camera system. These side-mounted camera systems cannot be manipulated by the CNC machine and therefore require regular manual calibration. Examples are side-mounted camera systems from Syntec Inc. of Hsinchu, Taiwan.

Other systems used for fixturing and inspecting parts include vision probes currently used with Coordinate Measuring Machines (CMMs). These sensors are attached to a computer controlled machine and are used for measuring parts “offline” (not during the manufacturing process) and are not designed for use in environments with harsh chemicals and oils, such as those seen during a CNC machining process. Examples include the Mitutoyo QVP Vision Probe and the Mitutoyo Vision Measuring System from Mitutoyo America Corporation of Aurora, Ill. Other examples are the Starrett Video Measuring System and the KineScope Hand Held Video Microscope from L.S. Starrett Company of Athol, Mass.

In general, existing inspection and measurement technologies use a standalone, tethered CNC controlled vision system for inspecting parts. Furthermore, these inspection and measurement technologies are not designed to withstand harsh environments generally suited for CNC machines and other manufacturing processes. These harsh environments can contain cutting oils and chemicals and pieces of metal being thrown in all directions.

Therefore, what is needed is a vision system that can be used in harsh environments.

### BRIEF SUMMARY OF THE TECHNOLOGY

The present embodiments overcome the aforementioned problems by providing a chuck or spindle mountable, wireless, battery powered non-contact vision system that can be integrated with and used by CNC machines and other manufacturing equipment operating in harsh environments. The vision system can be application specific and can serve as a touch probe replacement for x, y and z measurements, or any combination thereof, for example, x and y measurements. In contrast to the inspection and measurement technologies described above, the vision system can be designed to withstand harsh manufacturing environments generally suited for CNC and other machining and manufacturing processes. This environment can contain cutting oils and chemicals and pieces of metal being thrown in all directions.

Accordingly, embodiments of the present technology include a chuck or spindle mountable wireless vision system. The vision system comprises a sealed housing. The sealed housing includes a tool holder interface and a base, the tool holder interface coupled to a first end of the base, and a window on the second end of the base. An optical system is included to acquire an image through the window, the optical system including a processor, memory, and machine vision software. A wireless communication module is operatively coupled to the optical system to wirelessly communicate data, including image data generated by the machine vision software. And a power source, the power source operatively coupled to the optical system and the wireless communication module.

In accordance with another embodiment of the technology, a chuck or spindle mountable vision system. The vision system comprises a sealed housing, the sealed housing including a tool holder interface to couple to the chuck or spindle. An optical system to acquire an image, the optical system positioned within the sealed housing, the optical system including a processor, memory, and machine vision software to perform at least a portion of image processing. A wireless communication module is operatively coupled to the optical system to wirelessly communicate image data. And a power source, the power source operatively coupled to the optical system and the wireless communication module.

In accordance with another embodiment of the technology, embodiments of the present technology include a method for auto-calibrating a vision system, the vision system coupled to a chuck or spindle of a CNC machine, the CNC machine having a work space. The method comprises the steps of: a. acquiring at least one image of at least a portion of the work space; b. locating a feature in the image; c. rotating the spindle of the CNC machine; d. acquiring at least one new image of at least a portion of the work space; e. locating the feature in the at least one new image; f. calculating a center of rotation; g. moving the work space; h. acquiring at least one subsequent image of at least a portion of the work space; i. locating the feature in the at least one subsequent image; and j. creating a hand-eye calibration between the vision system and the CNC machine.

To the accomplishment of the foregoing and related ends, the embodiments, then, comprise the features hereinafter fully described. The following description and annexed drawings set forth in detail certain illustrative aspects of the technology. However, these aspects are indicative of but a few of the various ways in which the principles of the technology can be employed. Other aspects, advantages and novel features of the technology will become apparent from the following detailed description of the technology when considered in conjunction with the drawings.

### BRIEF DESCRIPTION OF THE SEVERAL VIEWS OF THE DRAWINGS

FIG. 1 is a schematic view of a vision system coupled to a CNC machine according to embodiments of the technology;

FIG. 2 is a perspective view of a vision system according to embodiments of the technology;

FIG. 3 is a close up perspective view of a portion of the vision system of FIG. 2 according to embodiments of the technology;

FIG. 4 is a side view of the vision system of FIG. 2 according to embodiments of the technology;

FIG. 5 is a bottom view of an exemplary vision system and showing the tool holder interface removed and a battery removed from the vision system, according to embodiments of the technology;

FIG. 6 is a perspective view of the vision system of FIG. 5 and showing the battery being installed into the housing of the vision system, according to embodiments of the technology;

FIG. 7 is a bottom view of a vision system and showing a sealed window according to embodiments of the technology;

FIG. 8 is a plan view of a vision system according to embodiments of the technology;

FIG. 9 is a perspective view in section of the vision system according to embodiments of the technology;

FIG. 10 is a plan view of a communication module usable with the vision system, according to embodiments of the technology;

FIG. 11 is a plan view of the communication module of FIG. 10, according to embodiments of the technology;

FIG. 12 is a flow chart of a method for auto-calibrating a vision system, according to embodiments of the technology;

FIG. 13 is a perspective view of an embodiment of a vision system similar to the vision system of FIG. 2, except showing a removable cover, according to embodiments of the technology;

FIG. 14 is a side view in section of a vision system and showing exemplary placement of components with the housing of the vision system, according to embodiments of the technology;

FIG. 15 is a perspective view of a vision system showing an antenna being installed, according to embodiments of the technology;

FIG. 16 is a perspective view of a vision system showing a battery being installed, according to embodiments of the technology;

FIG. 17 is a perspective view showing access for a battery switch, according to embodiments of the technology;

FIG. 18 is a perspective view of a vision system showing an optical system being installed, according to embodiments of the technology;

FIG. 19 is a perspective view of the vision system of FIG. 13 showing the removable cover being installed, according to embodiments of the technology;

FIGS. 20 and 21 are perspective views of retention features of the cover as seen in FIG. 19, according to embodiments of the technology; and

FIG. 22 is a perspective view in section showing release features of the cover.

While the technology is susceptible to various modifications and alternative forms, specific embodiments thereof have been shown by way of example in the drawings and are herein described in detail. It should be understood, however, that the description herein of specific embodiments is not intended to limit the technology to the particular forms disclosed, but on the contrary, the intention is to cover all modifications, equivalents, and alternatives falling within the spirit and scope of the technology as defined by the appended claims.

### DETAILED DESCRIPTION OF THE TECHNOLOGY

The various aspects of the subject technology are now described with reference to the annexed drawings, wherein like reference numerals correspond to similar elements throughout the several views. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system,” “device” and the like are intended to refer to either hardware, a combination of hardware and software, software, or software in execution. The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques and/or programming to produce hardware, firmware, software, or any combination thereof to control an electronic based device to implement aspects detailed herein.

Unless specified or limited otherwise, the terms “connected,” and “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically.

As used herein, the term “processor” may include one or more processors and memories and/or one or more programmable hardware elements. As used herein, the term “processor” is intended to include any of types of processors, CPUs, microcontrollers, digital signal processors, or other devices capable of executing software instructions.

As used herein, the term “memory” includes a non-volatile medium, e.g., a magnetic media or hard disk, optical storage, or flash memory; a volatile medium, such as system memory, e.g., random access memory (RAM) such as DRAM, SRAM, EDO RAM, RAMBUS RAM, DR DRAM, etc.; or an installation medium, such as software media, e.g., a CD-ROM, or floppy disks, on which programs may be stored and/or data communications may be buffered. The term “memory” may also include other types of memory or combinations thereof.

Embodiments of the technology are described below by using diagrams to illustrate either the structure or processing of embodiments used to implement the embodiments of the present technology. Using the diagrams in this manner to present embodiments of the technology should not be construed as limiting of its scope. The present technology contemplates a chuck or spindle mountable, wireless, battery powered vision system for use with machining and manufacturing equipment, including CNC machines, and that can be designed to withstand harsh environments generally suited for CNC and other machining processes.

The various embodiments of a chuck or spindle mountable vision system will be described in connection with a CNC machine, the CNC machine adapted to produce a part using various CNC controlled tools. That is because the features and advantages of the technology are well suited for this purpose. Still, it should be appreciated that the various aspects of the technology can be applied in other forms of vision systems and manufacturing and machining equipment that may benefit from a vision system having the features described herein.

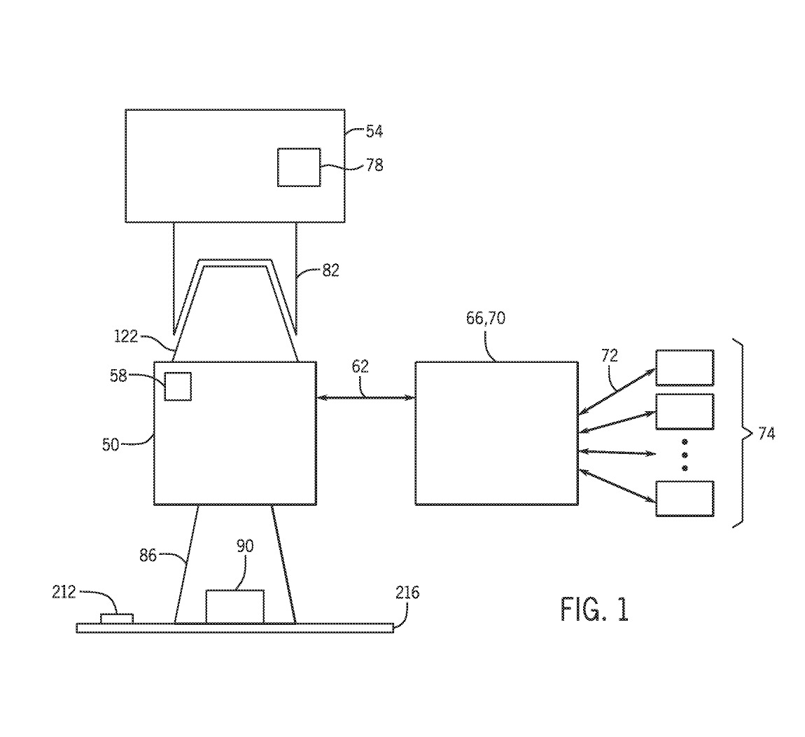

Referring now to FIG. 1, the present technology will be described in the context of an exemplary vision system 50 usable with a CNC machine 54. It is to be appreciated that a robot, for example, can be used in place of a CNC machine. The vision system 50 can be embedded with machine vision software 58, and can include wireless communications 62 for communication with a router 66 or a wireless network 70, for example. The router 66 or wireless network 70 can communicate wired or wirelessly 72 with other devices 74, such as a PC, and/or other receivers or CNC controllers 78 that can include machine vision software and communicate with the vision system 50 to provide closed-loop control. The vision system 50 can function as a CNC tool and can have an accompanying PC perform all, or part of, the image processing.

The vision system 50 can run complex machine vision algorithms used for detecting printed fiducials and homing marks, pattern recognition, 2-D or 3-D calibration, alignment, measurement, and inspection, as non-limiting examples, and can be used real-time during the machining process.

When used with a CNC machine, for example, the vision system 50 can be an alternative to touch probes due to the time required for touch probes to determine the two dimensional and/or three dimensional position of a part being machined. The vision system 50 mounted as a CNC tool and manipulated by the CNC machine can make this process faster because it is a non-contact sensor. Furthermore, the vision system 50 can detect and measure features on a part that cannot be physically located by touch, such as printed fiducials marks or other 2-D or 3-D part features, as non-limiting examples.

As seen in FIG. 1, the vision system 50 can be mounted in a chuck or spindle 82 of the CNC machine 54. Vision system 50 has a field of view 86, and the vision system 50 can be positioned by the CNC machine 54 such that the field of view 86 can include at least a portion of the part 90 being worked on by the CNC machine 54, although not required. The vision system 50 is portable and can be easily attached to a CNC tool holder regardless of the tool holder's size or dimensions. In this regard, a variable form factor allows use with automatic tool changers and without human installation and calibration.

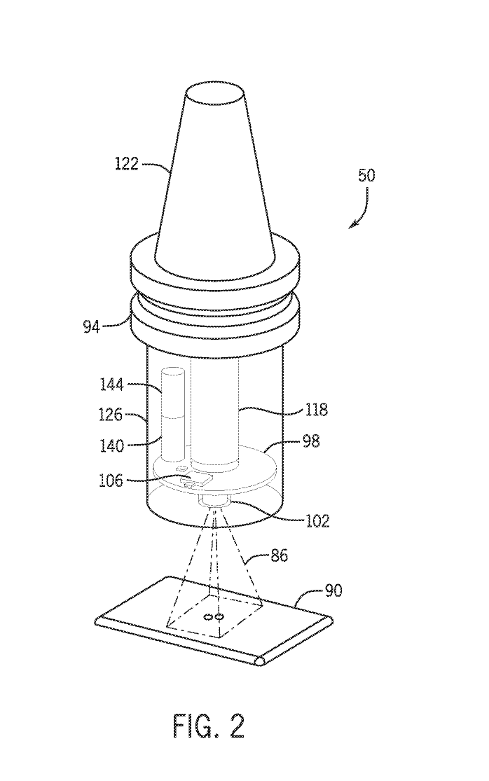

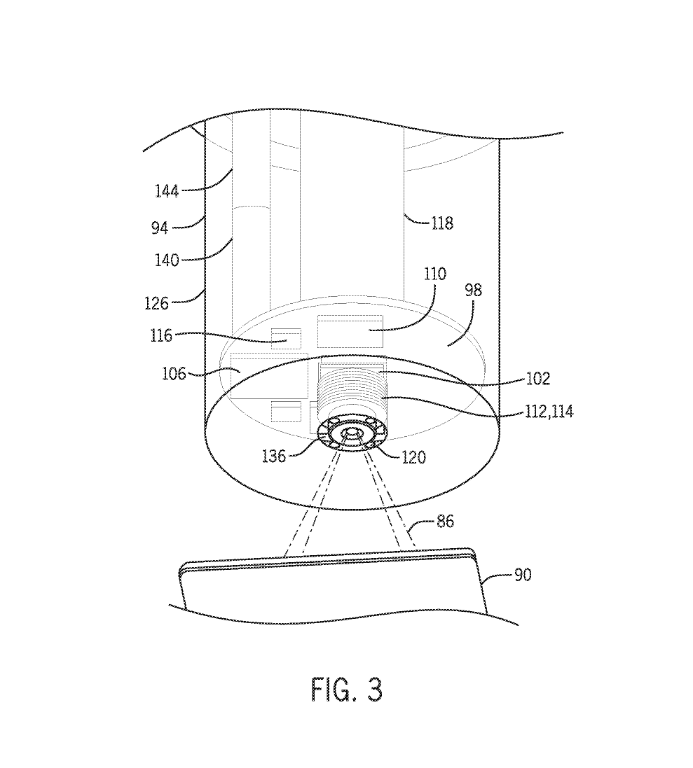

Referring to FIGS. 2-4, in some embodiments, the vision system 50 can include a housing 94. The housing 94 can be liquid resistant and/or waterproof so as to achieve ingress protection standards for IPXX and/or NEMA standards, and can have a variable form factor that enables the vision system 50 to be mounted as a tool on the spindle 82 of the CNC machine 54 so the vision system 50 can be freely spun and repositioned in the same way as any other tool usable by the CNC machine 54. IP ratings (and equivalent NEMA ratings) can include all known IP ratings from IP00 (unprotected) through IP69K. In some embodiments useful in the CNC machining environment, the vision system 50 can achieve an IP rating of IP67, although unprotected through IP69K ratings are also contemplated.

In addition to being mountable in a chuck or spindle 82 of the CNC machine 54, the housing 94 can be sized and configured to enclose an optical system 98 having a camera sensor 102, including CMOS, CCD, or other known sensor technologies, including laser technologies, and a processor 106, memory 110, including RAM and/or flash, used to perform one or more of calibration, alignment, measurement, inspection, code reading, and/or other machine vision tasks from the camera sensor 102. The optical system 98 can include optics 112 including lens 114, filters, such as bandpass filters, neutral-density filters, and polarizers, for example. Processor 106 can execute programs stored in memory 110 to perform inventive processes. Each of the processor 106, camera sensor 102, memory 110, optics 112, power source 118, and light source 120 can be mounted in or otherwise supported within the housing 94. Processor 106 can be coupled to each of camera sensor 102, memory 110, optics 112, power source 118, and light source 120.

The housing 94 can include a tool holder interface 122. The tool holder interface 122 can be similar to that of any normal drill bit or end mill used with a CNC machine. In some examples, the tool holder interface 122 can include a pull stud 124, for example. The tool holder interface 122 can take on any known or future developed shape to interface with any chuck or spindle, for example. This can be accomplished using a custom tool holder interface specific to a machine manufacturer that the vision system 50 can use to interface with the chuck or spindle of the machine. In some embodiments, the vision system 50 can be screwed onto a collet on a CNC tool holder to create a watertight seal.

The housing 94 can also include a base 126 to house components of the vision system 50. In some embodiments, the base 126 can be tubular, although other geometries are possible. A first end 130 of the base 126 can sealingly couple to the tool holder interface 122, and a second end 134 of the base 126 can include a window 136 for the camera sensor 102 to acquire and take images of the field of view 86. It is to be appreciated that the tool holder interface 122 and the base 126 can be a single piece, or can be several pieces coupled together.

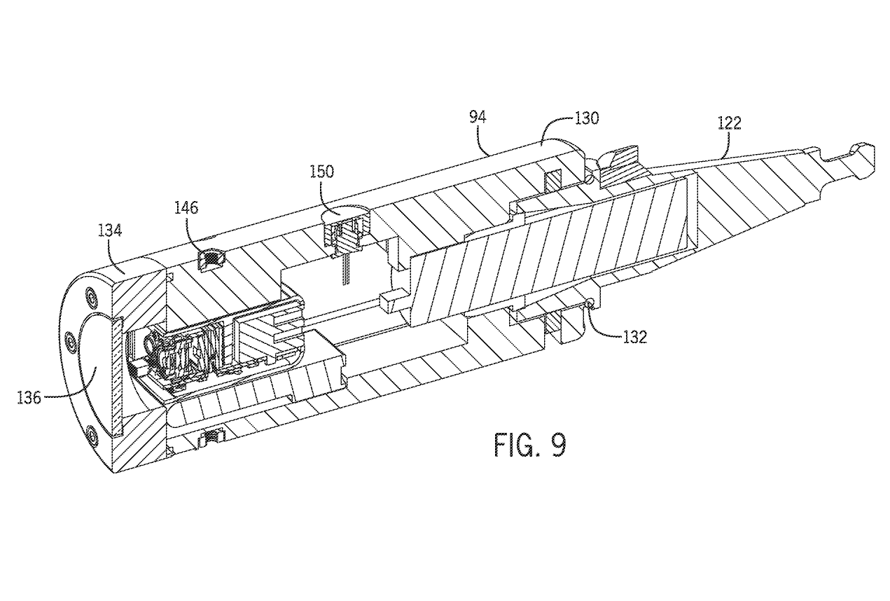

A gasket 132, such as an O-ring for example, can be used to maintain the predetermined IPXX ratings (see FIGS. 8 and 9). The window 136 can also be sealed to maintain the predetermined IPXX and/or NEMA ratings of the vision system 50. The window 136 can be glass or polycarbonate, for example, and can be clear or colored, and can be scratch resistant and/or non-stick to prevent residue from accumulating on the window.

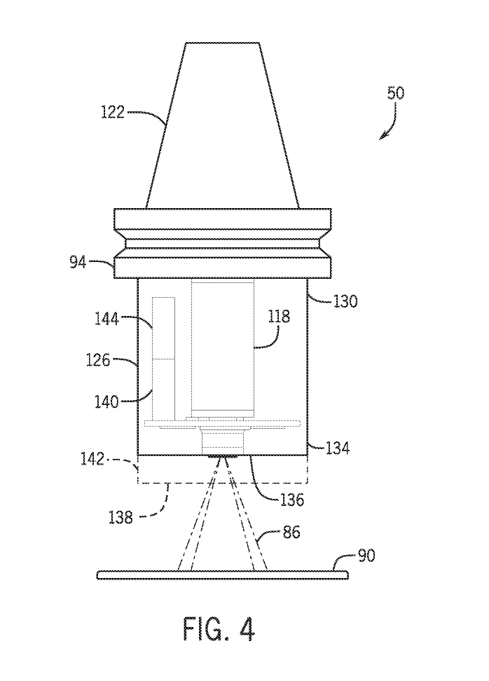

Based on a user's application, for example, the user can remove and replace the lens 114 for one that is more suitable for the application. A new lens can be physically longer or shorter than the existing lens, and/or a new lens can provide a longer or shorter focal length, for example. In some embodiments, the housing 94 can allow for the attachment/removal of a housing extension 142 (shown in dashed lines in FIG. 4) in order to insure that the optical system remains within the confines of the extended housing 94 including window 138, while still maintaining a suitable optical path between the camera sensor 102, lens 114, and the housing window 138, and maintaining the desired IP rating. In some embodiments, the lens 114 can be manually adjusted by the operator or adjusted automatically using a liquid lens or electro-mechanical mechanism.

In some embodiments, the vision system 50 can include a communication module 140, such as a WiFi module or other known communication technologies for wireless communications 62 of images and data of any type to and from the vision system 50. Many known wireless protocols are available, for example 802.11n WLAN, as a non-limiting example. The communication module 140 can include an antenna 144 positioned within or outside the housing 94. Other embodiments can include wired communications.

A power source 118, e.g., a battery, can be positioned within the housing 94. The battery can be replaceable and/or rechargeable. The power source 118 can also be inductively charged within or outside the housing 94. The vision system 50 can incorporate a wireless wake-up scheme for power conservation. Using the wireless communications 62, the vision system 50 can be instructed to shut down when not in use, and power back up when needed. In other embodiments, an orientation sensing device 116, e.g., an accelerometer or gyroscope, can be included to detect when the vision system 50 is in a down, or in use, orientation. In some embodiments, the down orientation can be the primary time when the CNC machine 54 uses vision system 50. Use of the orientation sensing device 116 can also be used to conserve power when the vision system is not in use.

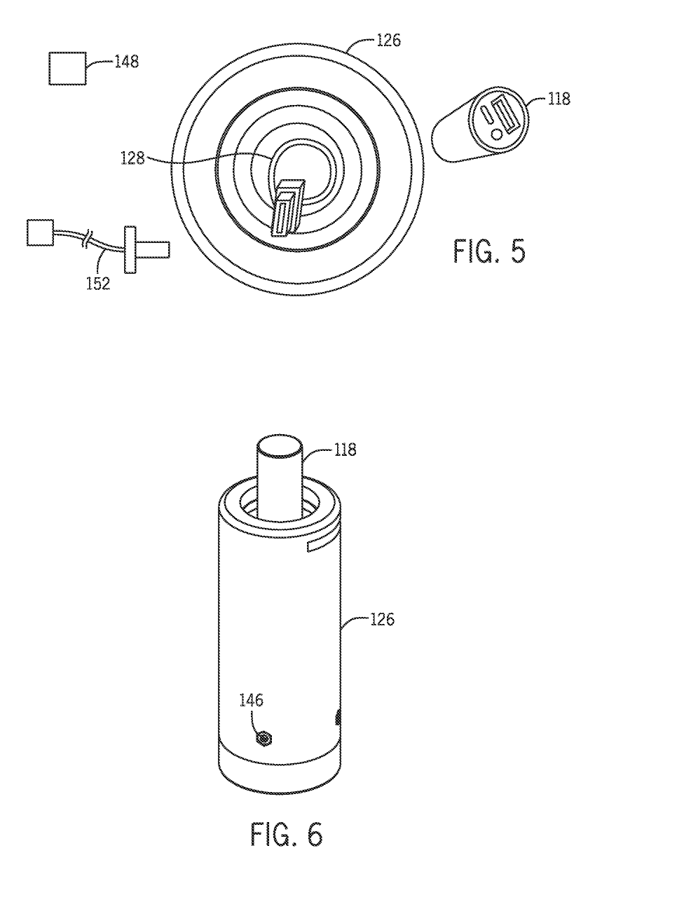

Referring to FIGS. 5-6, in some embodiments, the tool holder interface 122 and/or the second end 134 can be removable to allow the vision system 50 to include a battery cable 128 to simplify removal and recharging and replacement of the battery 118. FIG. 5 shows a view looking into the housing 94 with the tool holder interface removed such that the battery cable 128 is visible and accessible to connect to the battery 118. The vision system 50 can include a battery charging station 148 and/or charging cable 152. FIG. 6 shows a perspective view with the battery 118 connected to the battery cable 128 and being inserted into the base 126.

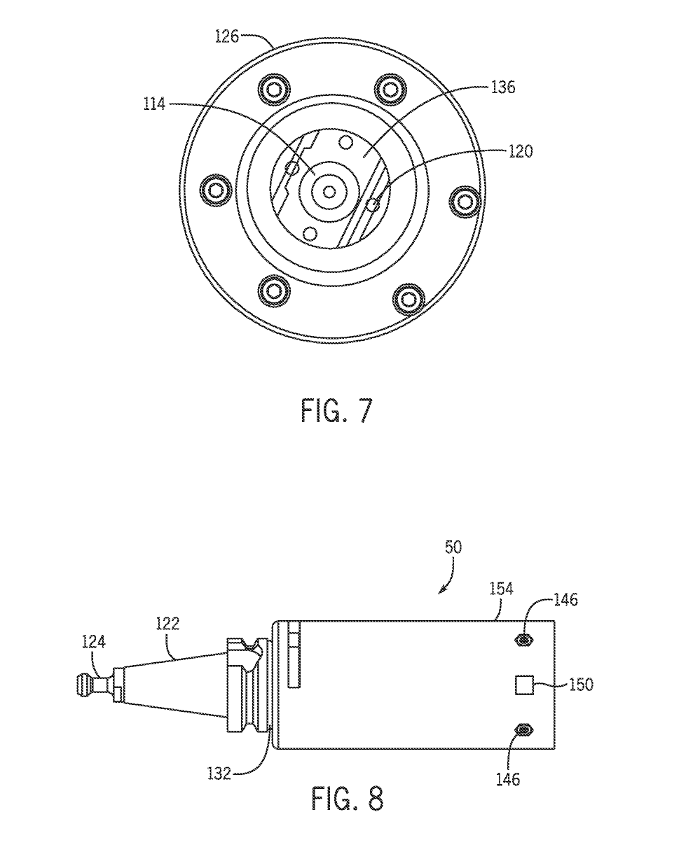

Referring to FIG. 7, illumination of the field of view 86 can be provided by an illumination source 120, e.g., an arrangement of one or more LEDs, positioned within or on the housing 94. The arrangement can be linear, circular, or form an arbitrary pattern. The illumination source 120 can be powered by the power source 118. The illumination may be directed to the field of view using known mechanisms to direct the illumination, including light pipes, reflectors, focusing lenses, polarizing or filtering material, and diffusers, for example. The illumination source 120 can be arranged to produce on-axis illumination, i.e., bright field illumination, off-axis illumination, i.e., dark field illumination, in different colors, or a combination.

Referring to FIG. 8, the housing 94 can also include mounting hole(s) 146 and power connection(s) 150 for external lighting to be mounted on the exterior 154 of the housing 94. The external lighting can be optional and can be user-exchangeable, and can be controlled by the vision system 50. Examples of external lighting that can be employed include on-axis illumination, off-axis illumination, and dome-based illuminators, as non-limiting examples.

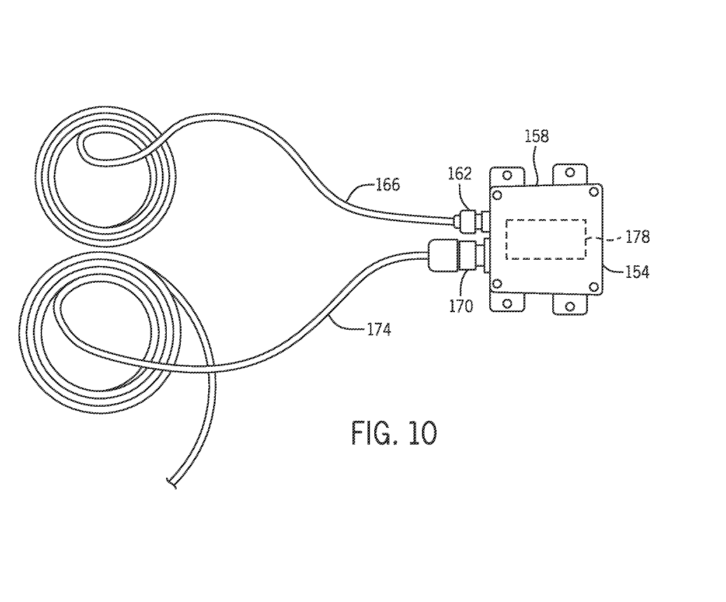

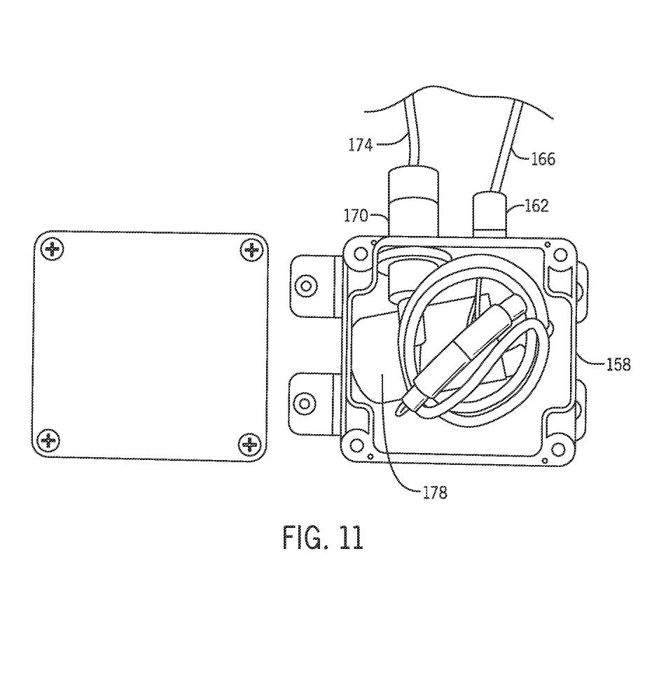

Referring to FIGS. 10-11, a wireless communication adapter 158 can be used to transmit and receive the wireless communications 62 to and from the vision system 50 and can be mounted anywhere within communication range from the vision system 50. The wireless communications 62 can then be relayed wired or wirelessly from the communication adapter 158 to an Ethernet connection or wireless network card installed in a PC or industrial controller, or any device designated to receive data or images from the vision system 50, such as the CNC machine 54, or CNC controller 78, for example. The wireless communications 62 can be received by a single device or multiple devices. The wireless communication adapter 158 can be housed in a box 154 having the same or similar ratings as housing 94, e.g., IPXX and/or NEMA rating, e.g., IP67. The wireless communication adapter 158 can send wireless communications 62 to the vision system 50. The wireless communication adapter 158 can send control signals, e.g., such as the selection of the machine vision task or focus position, parametric information, e.g., such as machine vision task thresholds, images, or other data, or any combination thereof.

In the embodiment shown, the wireless communication adapter 158 can include an IPXX, e.g., IP67, rated power connector 162 and power cable 166 and an IPXX, e.g., IP67 rated network connector 170 and network cable 174, e.g., for Ethernet. The wireless communication adapter 158 can include a wireless repeater and bridge 178 coupled to the power cable 166 and network cable 174 to transmit and receive the wireless communications 62.

A known disadvantage with using a portable camera for machine vision for a CNC machine is that each time the camera must be remounted to the CNC machine. Small positional or angular variations in the camera's mounting can produce incorrect measurement results. This can be due to the way the camera was mounted or due to the manufacturing tolerances of the machine or a combination of both.

Since the vision system 50 can be mounted in the chuck or spindle of a CNC machine, the movements of the CNC machine can be used to perform an automatic field calibration for each use of the vision system 50 to ensure high accuracy. The vision system 50 can be accurate to about plus or minus one to two micrometers, for example, which is comparable to that of touch probes. The field calibration can allow the vision system 50 to translate pixel positions in its images to physical positions in the CNC machine's coordinate system.

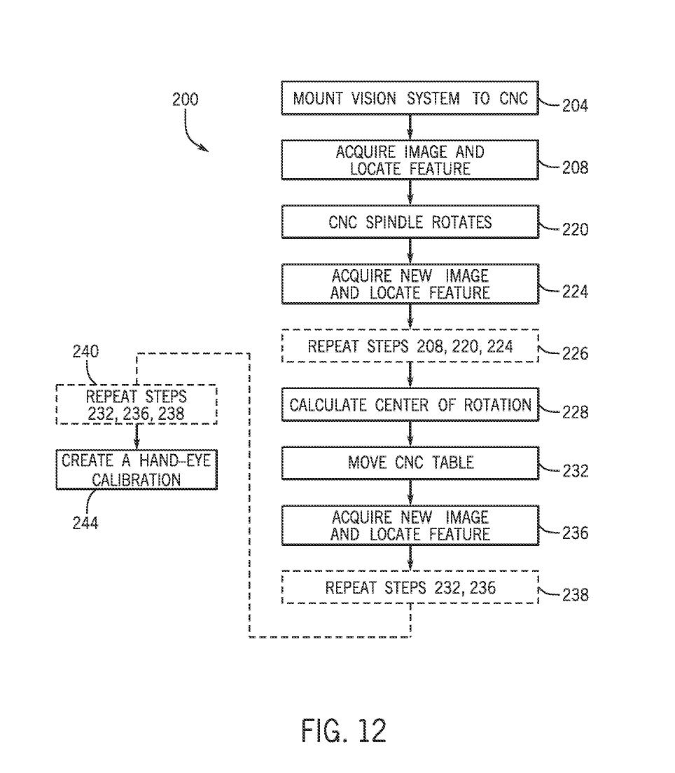

FIG. 12 illustrates an embodiment of a method for an automatic field calibration of the vision system 50. The method shown in FIG. 12 can be used in conjunction with any of the systems or devices described and/or shown in the Figures. In various embodiments, some of the method steps shown may be performed concurrently, in a different order than shown, or may be omitted. Additional method steps may also be performed as desired.

Referring to FIG. 12, a method 200 is shown for an automatic field calibration of the vision system 50. A first step can be to mount the vision system 50 to the CNC chuck or spindle 82, as indicated at process block 204. The CNC machine 54 can perform this step. Next, at process block 208, the vision system 50 can acquire at least one image and locate at least one feature 212 on the CNC work table 216 (see FIG. 1). The at least one image may be stored in memory 110. Non-limiting examples of a feature 212 can include a calibration plate, a fiducial on the table 216, and/or a texture on the table. At process block 220, the CNC spindle 82 can then perform at least one movement, e.g., a rotation, the rotation causing the vision system 50 to rotate as well. The vision system 50 can then acquire and store at least one new image and again locate at least one feature 212, as indicated at process block 224. The at least one new image may also be stored in memory 110. In some embodiments, at optional process block 226, the steps indicated at process blocks 208, 220, and 224 can be repeated at least one time, or for example, two times, three times, four times, until sufficient data is taken. In this context, sufficient data can refer to a sufficient number of images to calculate a vision system 50 calibration with the desired accuracy and degrees of freedom. The at least one feature 212 can be found in the images, and the feature is used to determine a relationship between machine movement and apparent movement of the feature 212 in the image. The number of images required to do this can depend on the type of motion the machine is capable of. At least one example of movement along each degree of freedom of the machine can be used. More than one image can improve accuracy and, optionally, when more than one image is acquired, modeling of distortion can be accomplished. At process block 228, the vision system 50 can then calculate its center of rotation using the data gathered process blocks 208, 220, and 224. The result of the calculation of the center of rotation can then serve as the origin of the CNC machine's coordinate system.

Next, at process block 232, the CNC machine 54 can move its table 216 a small distance, e.g., one millimeter, ten millimeters, or fifty millimeters for example, along one axis. The amount the CNC machine 54 is to move its table 216 can be predetermined and known by the vision system 50 ahead of time. The vision system 50 can then record at least one additional new image and locate the at least one feature 212, as indicated at process block 236. In some embodiments, at optional process block 238, the steps indicated at process blocks 232 and 236 can be repeated at least one time, or for example, two times, three times, four times, until sufficient data is taken, e.g., as described above, such that feature correspondences have been collected to calculate a vision system 50 calibration with a given number of degrees of freedom at a given level of accuracy. In some embodiments, as indicated at process block 240, the steps indicated at process blocks 232, 236, and 238 can be repeated for additional table axes, if necessary for the application.

After the above steps are completed, the vision system 50 can then create a hand-eye calibration using well known techniques, as indicated at process block 244. Method 200 can be a setup step for the vision system 50 and can be completed in only a few seconds. Once completed, run-time images can be acquired during a machining process.

Several examples are provided to describe exemplary uses of the vision system 50. A user can quickly place multiple parts at arbitrary locations on the CNC machine's work table 216. The vision system 50 can locate all the parts in the CNC machine's coordinate system, and the CNC machine 54 can then use those coordinates to drill a pattern of holes in each part.

In some applications, the height of a part is unknown or uneven, but the CNC machine 54 must perform some action relative to the part's top surface. The vision system 50 can take an image of the part 90 on the work table 216. The CNC machine 54 can translate the part to a fixed, relative location. The vision system 50 can take at least a second image of the part. These images form a stereo pair, which can allow the vision system 50 to sense the precise height of the part at any location. This height can then be used for operations performed on the part, such as engraving, grinding, or routing, as non-limiting examples.

In some applications, a material such as metal, or glass can be cut by the CNC machine 54. The CNC machine 54 can cut the part using a cutting tool, and then switch the cutting tool to the vision system 50. The CNC machine 54 can then use the vision system 50 to inspect the cut part for cracks or other imperfections.

In some applications, the CNC machine can finish working on a part and the part can then be removed from the work space or work table 216. The CNC machine 54 can switch out the previous tool with the vision system 50. The vision system 50 can then be used to inspect the work table 216 for debris or other obstructions to ensure that the work space is desirable for another part to be worked on without any issues.

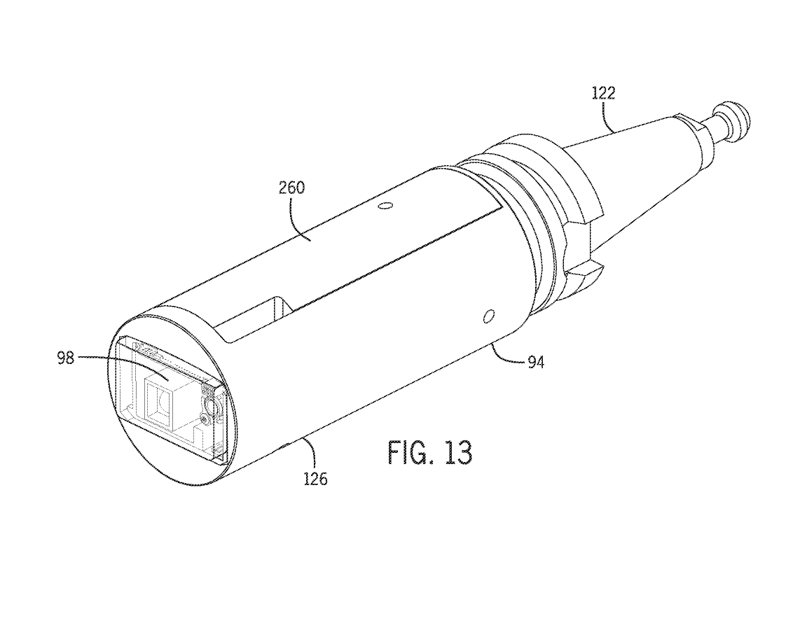

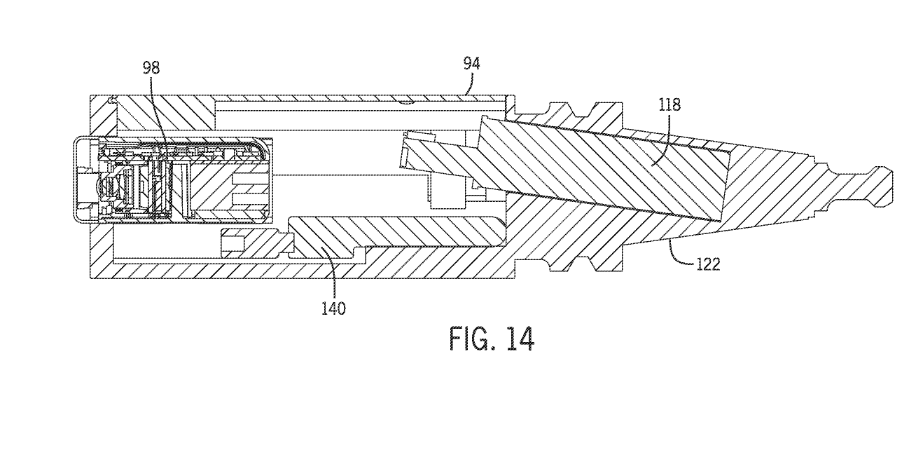

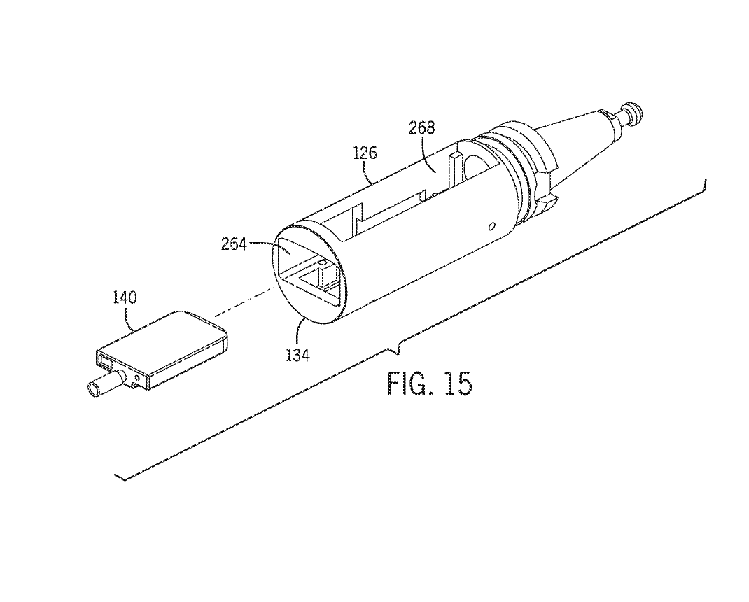

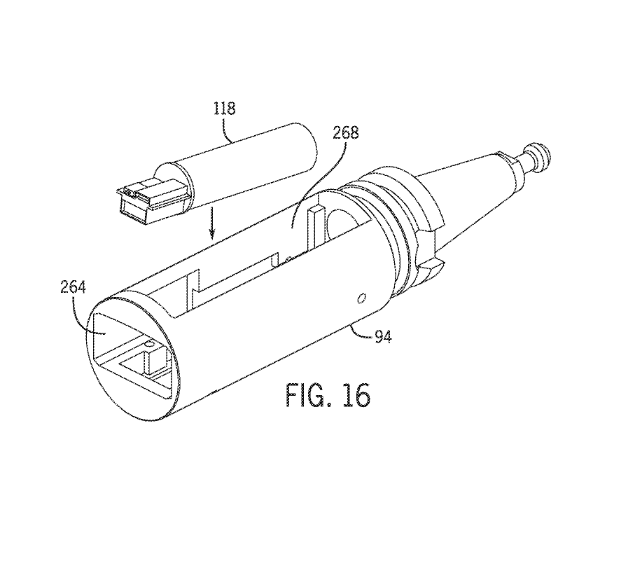

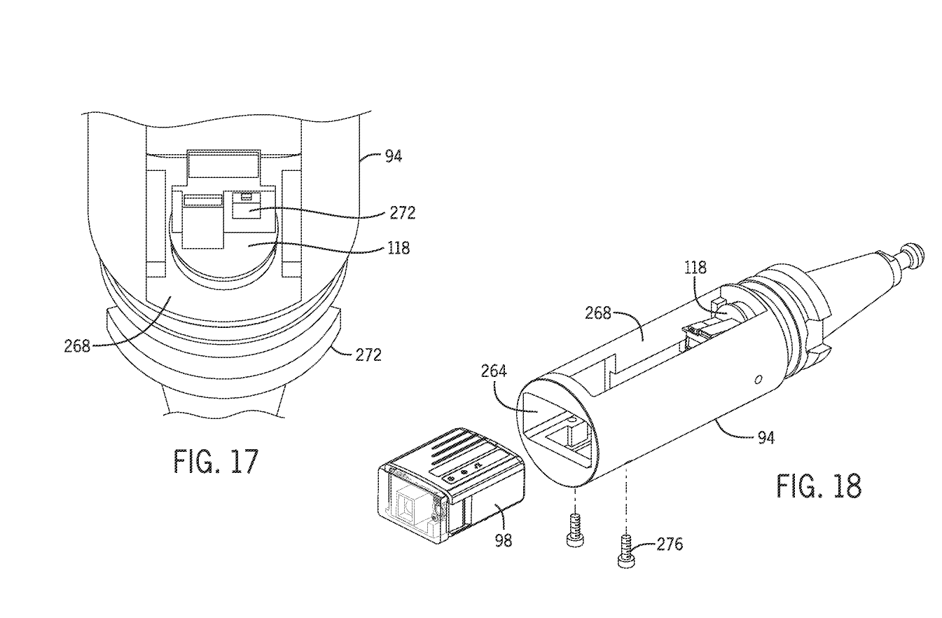

Referring to FIG. 13, in some embodiments, the housing 94 can include a cover 260 for access within the base 126. FIG. 14 shows a side view in section of the housing 94 with the optical system 98, communication module 140, and battery 118 positioned within the housing 94. As seen in FIG. 15, in some embodiments, the communication module 140 can be inserted into the base 126 through opening 264 at the second end 134. With the cover 260 removed and the communication module 140 in place, the battery 118 can be placed through opening 268 and within the housing 94, as seen in FIG. 16. FIG. 17 shows the battery 118 positioned within the housing 94 and having a battery switch 272 accessible. The battery switch 272 can be used to enable or disable the battery from supplying power. As seen in FIG. 18, the optical system 98 can then be inserted through the opening 264 and secured in place with fasteners 276. The communication module 140, battery 118 and optical system 98 can be operatively coupled together.

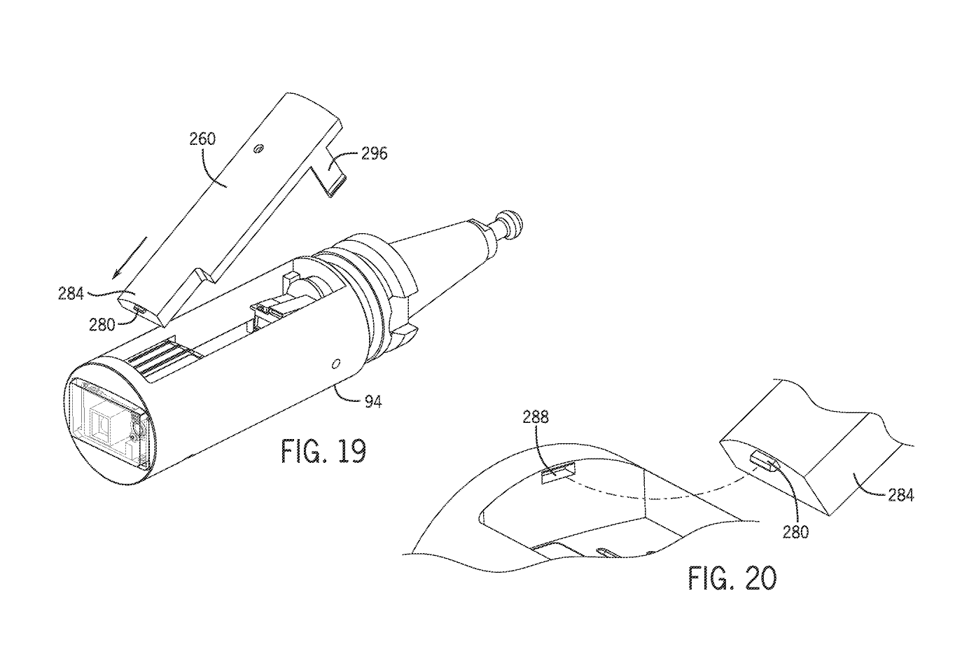

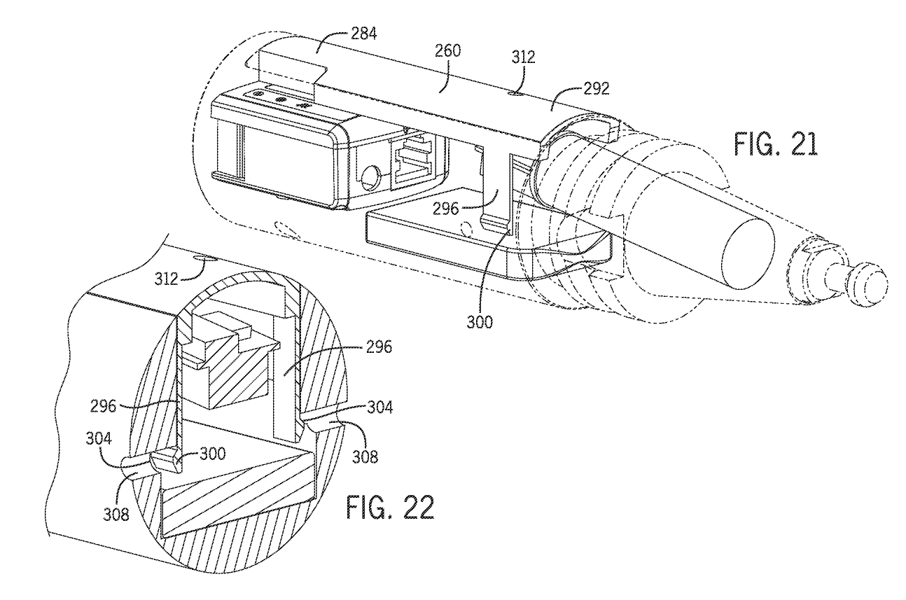

With the components installed within the housing 94, the cover 260 can be positioned back on the housing 94. In some embodiments, the cover 260 can be installed by first engaging a cleat 280 on the cover first end 284 with a slot 288 in the housing 94, as seen in FIGS. 19 and 20. Referring to FIGS. 21 and 22, the cover second end 292 can include at least one spring clip 296, e.g., two are shown. The spring clip 296 can include a cleat 300 that can engage with a mating detent 304 in the housing 94. In some embodiments, the housing 94 can include an aperture 308, e.g., two are shown, through the housing 94 that allows a tool to be inserted into the aperture 308 to disengage the cover spring clip 296 from the detent 304 in the housing 94 when the cover is to be removed. In some embodiments, and as seen in FIG. 22, the housing 94 can also include a battery switch aperture 312 that allows a tool to be inserted into the aperture 312 to turn the battery on and off. The housing 94 can be made of materials able to withstand contact with harsh chemicals. For example, the housing can be made of metals or plastics, or a combination.

Although the present technology has been described with reference to preferred embodiments, workers skilled in the art will recognize that changes may be made in form and detail without departing from the spirit and scope of the technology. For example, the present technology is not limited to a vision system for a CNC machine, and may be practiced with other machines having moving components. For example, although use with a CNC machine is shown and described above, the vision system can be used with a robot, for example. The robot may pick up the vision system and move the vision system as needed to determine working conditions for a work piece or to perform an inspection, for example.

The particular embodiments disclosed above are illustrative only, as the technology may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the technology. Accordingly, the protection sought herein is as set forth in the claims below.

What is claimed is:

1. A chuck or spindle mountable vision system, the system comprising:
a sealed housing, the sealed housing including a tool holder interface and a base, the tool holder interface coupled to a first end of the base, and a window on the second end of the base;
an optical system to acquire an image through the window, the optical system including a processor, memory, and machine vision software;
a wireless communication module operatively coupled to the optical system to wirelessly communicate data, including image data generated by the machine vision software; and
a power source, the power source operatively coupled to the optical system and the wireless communication module.

2. The system according to claim 1,
wherein the optical system is a non-contact optical system.

3. The system according to claim 1,
wherein the vision system is mounted to the chuck or spindle of a CNC machine.

4. The system according to claim 1,
wherein the tool holder interface is mounted to the chuck or spindle of a CNC machine.

5. The system according to claim 3,
wherein the vision system acquires the image and generates image data during a process controlled by the CNC machine.

6. The system according to claim 5,
wherein the wireless communication module wirelessly communicates the image data during the process controlled by the CNC machine.

7. The system according to claim 1,
wherein the power source is a rechargeable power source.

8. The system according to claim 1,
further including a communication adapter, the communication adapter to transmit and receive the wireless communications to and from the wireless communication module.

9. The system according to claim 1,
wherein the communication adapter is positioned in a box, the box having at least an IP67 or equivalent rating.

10. The system according to claim 1,
wherein the tool holder interface includes a pull stud.

11. The system according to claim 1,
wherein the sealed housing has at least an IP67 or equivalent rating.

12. A chuck or spindle mountable vision system, the system comprising:
a sealed housing, the sealed housing including a tool holder interface to couple to the chuck or spindle;
an optical system to acquire an image, the optical system positioned within the sealed housing, the optical system including a processor, memory, and machine vision software to perform at least a portion of image processing;
a wireless communication module operatively coupled to the optical system to wirelessly communicate image data; and
a power source, the power source operatively coupled to the optical system and the wireless communication module.

13. The system according to claim 12,
wherein the sealed housing has at least an IP67 or equivalent rating.

14. The system according to claim 12,
wherein the sealed housing further includes a base having a first end and a second end, the tool holder interface sealingly coupled to the first end of the base, the base including a window on the second end of the base.

15. A method for auto-calibrating a vision system, the vision system coupled to a chuck or spindle of a CNC machine, the CNC machine having a work space, the method comprising the steps of:
a. acquiring at least one image of at least a portion of the work space;
b. locating a feature in the image;
c. rotating the spindle of the CNC machine;
d. acquiring at least one new image of at least a portion of the work space;
e. locating the feature in the at least one new image;
f. calculating a center of rotation;
g. moving the work space;
h. acquiring at least one subsequent image of at least a portion of the work space;
i. locating the feature in the at least one subsequent image; and
j. creating a hand-eye calibration between the vision system and the CNC machine.

16. The method according to claim 15,
further including repeating steps a through e at least once before performing step f.

17. The method according to claim 15,
wherein the feature is one of a calibration plate, a fiducial on the work space, and a texture on the work space.

18. The method according to claim 15,
further including repeating steps h and i at least once before performing step j.

19. The method according to claim 18,
wherein repeating steps h and i acquires data for at least one additional work space axis.

20. The method according to claim 15,
wherein the vision system comprises an optical system, a wireless communication module, and a power source operatively coupled to the optical system and wireless communication module, the optical system, wireless communication module, and power source positioned within a sealed housing.

21. The method according to claim 20,
wherein the method is controlled by the CNC machine.

22. The method according to claim 15,
further including using the vision system to acquire a run-time image during a machining process controlled by the CNC machine.
